(19) United States
(12) Patent Application Publication
(10) Pub. No.: US 2007/0084547 A1
(43) Pub. Date: Apr. 19, 2007

(54) ROLL-TO-ROLL HEAT TRANSFER MACHINE

(75) Inventor: Donald G. Lane, Pittsburg, KS (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: HIX CORPORATION, Pittsburg, KS (US)

(21) Appl. No.: 11/422,672

(22) Filed: Jun. 7, 2006

Related U.S. Application Data
(60) Provisional application No. 60/726,056, filed on Oct. 13, 2005.

(51) Int. Cl. B65C 9/18; B44C 1/165; B44C 1/17

(52) U.S. Cl. 156/238; 156/230; 156/240; 156/540

(57) ABSTRACT

An apparatus for applying a pre-printed transfer to a substrate at an elevated temperature and under increased pressure is disclosed. The apparatus includes a framework, an enclosure containing a plurality of control mechanisms, a heated platen assembly, and an index mechanism. The heated platen assembly comprises a first member capable of vertical travel and a second member that is removable. The pre-printed transfer is positioned proximate the second member and the substrate is positioned proximate the first member. The index mechanism has at least a supply portion for holding a continuous web of pre-printed transfers and a collection portion for receiving the continuous web after the pre-printed transfer has been applied to the substrate. Also disclosed is a method of applying a pre-printed transfer to a desired substrate utilizing this apparatus.

### CROSS REFERENCE TO RELATED APPLICATIONS

This application claims the benefit of U.S. Provisional Application No. 60/726,056, filed on Oct. 13, 2005, having the same title and inventor.

### STATEMENT REGARDING FEDERALLY SPONSORED RESEARCH OR DEVELOPMENT

Not Applicable.

### TECHNICAL FIELD

This invention relates to heat transfer devices, more particularly to a device that can be used to quickly and effectively apply a variety of transfers to accepting substrates.

### BACKGROUND OF THE INVENTION

Heat transfer labels are a well known means of applying symbols, designs, and/or information to the surface of an object. These types of labels have been known to be applied to bottles and containers to identify the product contained therein and information about the product. More recently this type of technology has become more popular in other areas such as textiles. In such a configuration, traditional tags in garments and other fabrics that contain information such as manufacturer, material composition, and care instructions are replaced by heat transfer labels that are applied directly to the garment or fabric, thereby eliminating the need for a tag altogether.

Heat-transfer assemblies are well-known and widely used in the art. Most heat transfer assemblies are manufactured as a continuous roll of pre-printed transfers having multiple parts. Traditionally, heat transfer labels comprise a label-carrying continuous web, such as a polyethylene coated paper, a release layer such as a wax release, and a heat transfer label. The heat transfer label is affixed to the release layer, which is in turn affixed to the continuous web. Various compositions of materials have been identified to form the heat transfer labels. Depending upon the application, heat transfer labels are formed in single sheets or in a roll and contain a design or desired information that is printed with ink on the label. The label is dried at an elevated temperature until the ink has gelled sufficient to be dry to the touch. Drying the ink too much prevents the ink from re-melting. These prints, or transfers, once dried can be stored until needed.

A typical pre-printed transfer formed by this process is made from Plastisol. For a Plastisol transfer the ink applied to the transfer surface is initially dried at a temperature between 180 and 250 degrees Fahrenheit. For application of the transfer to the surface of an object, the transfer is exposed to a higher temperature, typically upwards of 350 degrees Fahrenheit.

Apparatus for applying a heat transfer label to containers or bottles in mass quantities are well known in the art. These type of apparatus dispose a portion of the heat-transfer label against a pre-heating device thereby causing the wax release layer to begin to melt, creating a weakened adhesion between the heat transfer label and the continuous web. Next, the heated labels are disposed against a label transfer system. The label transfer system subjects the label to additional heat while pressing the adhesive layer of the label into contact with the object. Depending on the type of heat transfer label, the label materials, and the object to which it is being applied, the label transfer process can be accomplished at various speeds, often times up to 400 objects per minute. This type of process and apparatus, is most applicable for the application of labels to bottles or containers.

With respect to the application of labels or other designs to fabrics or garments, previous equipment for applying such information involved a traditional press and a single heat-transfer label. An example of this traditional press is disclosed in U.S. Pat. No. 6,058,834, which was assigned to the same assignee as the present application. While this type of press can be used on a variety of objects, including clothing, it only allows for a single heat transfer label to be used at a time and is not automated.

### BRIEF SUMMARY OF THE INVENTION

The present invention is an apparatus that applies a pre-printed transfer to a substrate at an elevated temperature and under increased pressure. The apparatus comprises a framework, an enclosure containing a plurality of control mechanisms, a heated platen assembly, and an index mechanism. The heated platen assembly comprises a heat head capable of vertical travel and a removable lower platen as well as a skirt assembly. The index mechanism has at least a supply portion for holding a continuous web of pre-printed transfer and a collection portion for receiving the continuous web after the pre-printed transfer has been applied to the substrate.

The apparatus is configured such that the web of pre-printed transfer is positioned to be in contact with the lower platen and the heat head is in direct contact with the substrate. Under this arrangement, the pre-printed transfer on the continuous web is heated indirectly through heat that is applied to the substrate. The pre-printed transfer is heated to a temperature for a time period sufficient to apply the transfer to the substrate under pressure.

A method of operation of the apparatus is also disclosed herein. The method details the steps necessary to operate the apparatus so as to successfully apply a transfer from a roll to a substrate of choice.

It is an object of the present invention to provide a novel apparatus for and method of applying a heat applied transfer to a substrate with the pre-printed transfer stored on a continuous web.

It is another object of the present invention to provide an apparatus having control mechanisms for setting and maintaining temperature and pressure levels and dwell time as input by an operator for providing efficient and accurate application of a transfer to a substrate.

It is yet another object of the present invention to provide an apparatus capable of indexing the continuous web of heat applied transfer through a print area.

It is intended that any other advantages and objects of the present invention that become apparent or obvious from the detailed description or illustrations contained herein are within the scope of the present invention.

### BRIEF DESCRIPTION OF THE SEVERAL VIEWS OF THE DRAWING

The features of the invention noted above are explained in more detail with more reference to the embodiment illustrated in the attached drawing figures, in which like reference numerals denote like elements, in which FIGS. 1-7 illustrate an embodiment of the present invention, and in which:

FIG. 1 is a perspective view of a heat transfer apparatus in accordance with an embodiment of the present invention;

FIG. 2 is a front elevation view of the apparatus of FIG. 1;

FIG. 3 is a right side elevation view of the apparatus of FIG. 1;

FIG. 4 is a front elevation view of the reel assembly portion of the apparatus of FIG. 2 containing a roll of transfers;

FIG. 5 is an enlarge fragmentary front elevation view of a portion of the heated platen assembly of the apparatus of FIG. 4;

FIG. 6 is a left side elevation view of the apparatus of FIG. 1 with a portion of the enclosure removed for clarity; and

FIG. 7 is a front elevation view of the apparatus of FIG. 2 with the enclosure removed for clarity.

### DETAILED DESCRIPTION OF THE INVENTION

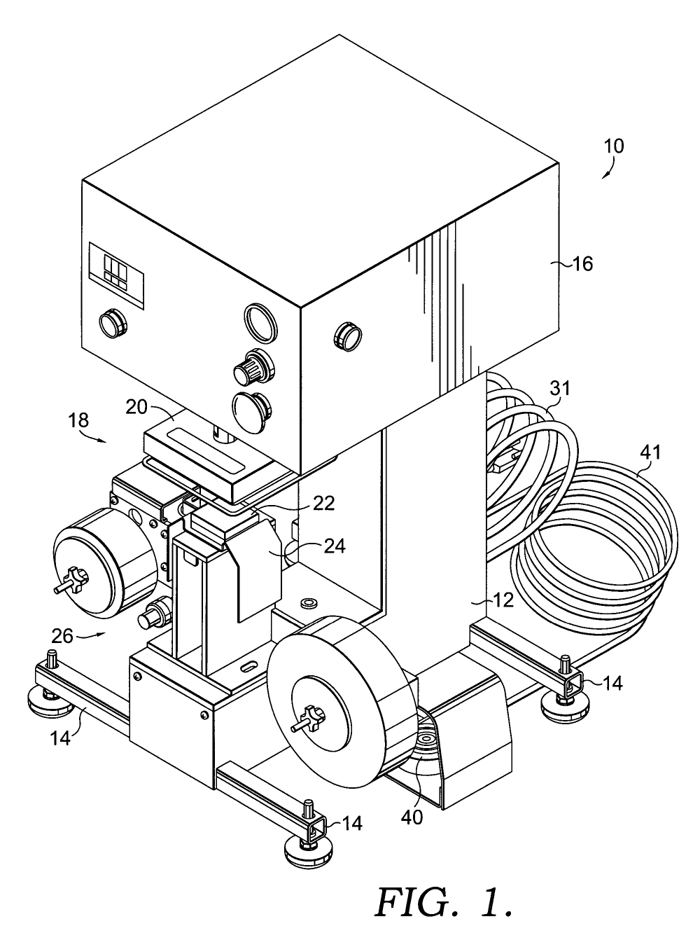

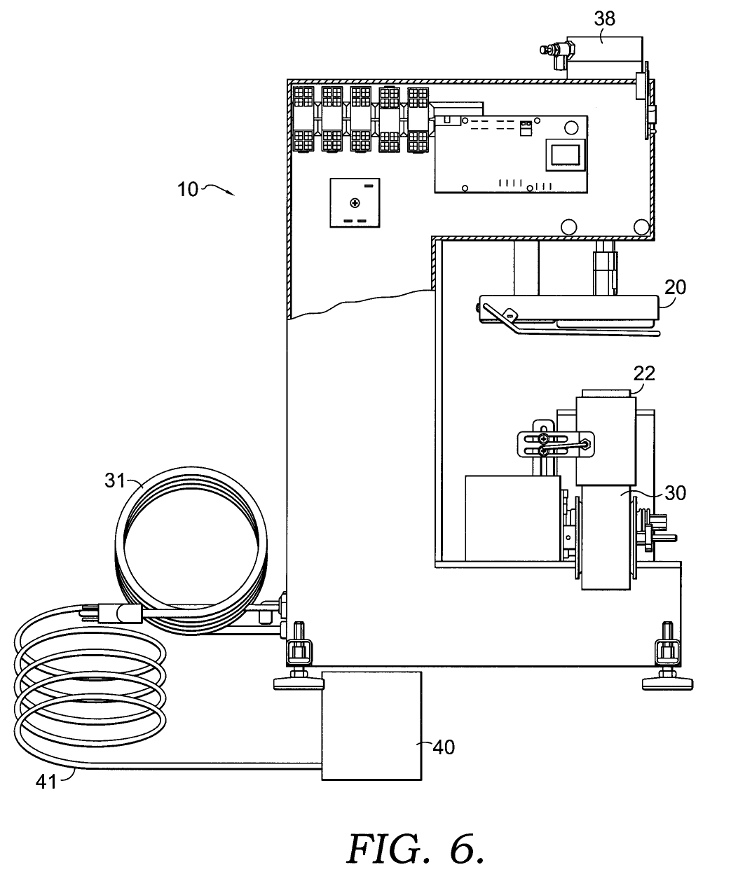

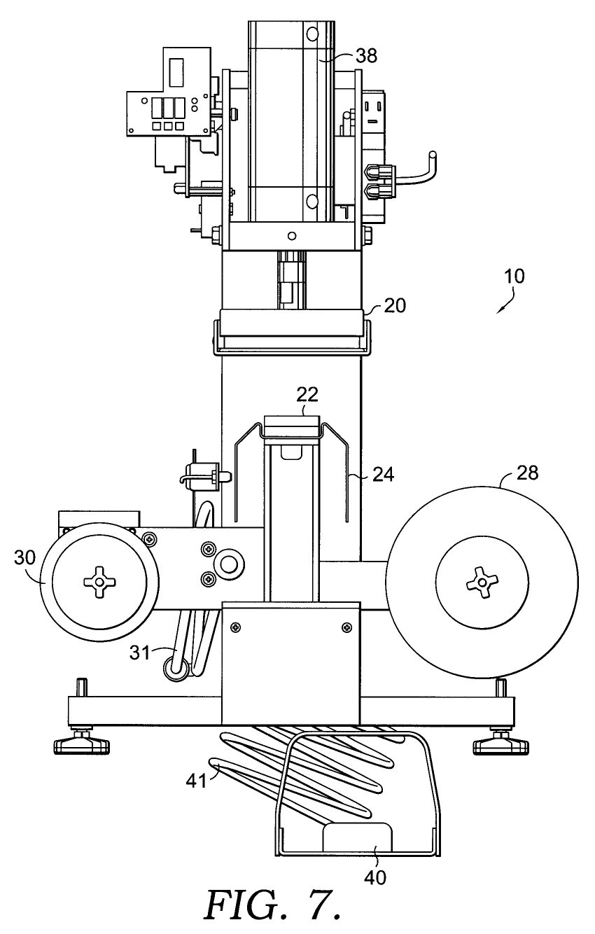

Referring now to the drawings in more detail and initially to FIG. 1, an embodiment of an apparatus 10 for transferring an object from a first surface to a second surface at an elevated temperature and increased pressure is shown. The apparatus 10 includes a framework 12 having a plurality of supports 14 proximate a lower end thereof for supporting the apparatus 10 on a table top, flooring surface or other suitable location. Positioned opposite of the support posts 14 proximate an upper end of the framework 12 is an enclosure 16. Contained within the enclosure 16 is a plurality of control mechanisms for programming and controlling the apparatus 10. Control mechanisms contained within enclosure 16 are those required for setting and maintaining a temperature and pressure, as well as controls for timing and position adjustment. These control mechanisms are shown in FIGS. 6 and 7.

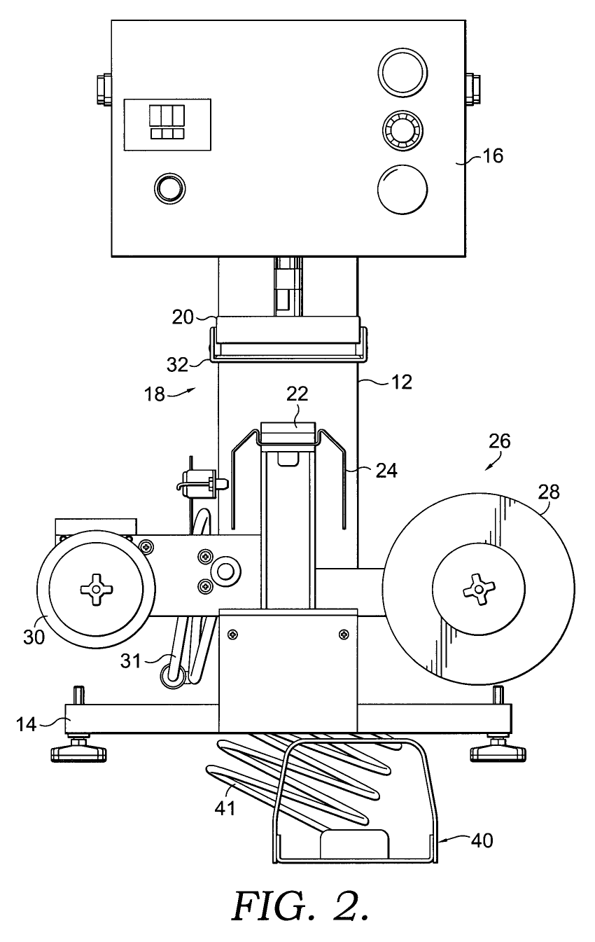

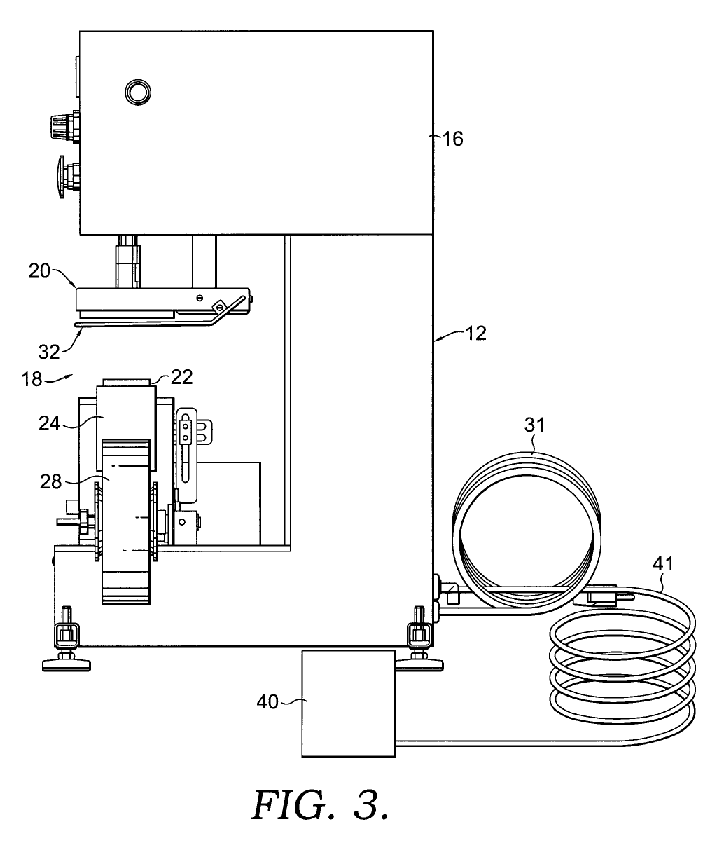

Another component of the apparatus 10 is a heated platen assembly 18, which can be seen more clearly in FIGS. 2, 3, and 5. The heated platen assembly 18 comprises a first member 20, also referred to as a heat head, that is capable of moving in a generally vertical direction, a second member 22, also referred to as a removable lower platen, and a skirt assembly 24. It is the heat head, or first member 20, that operates at an elevated temperature. The first and second members 20, 22 are positioned a distance apart such that there exists a space therebetween.

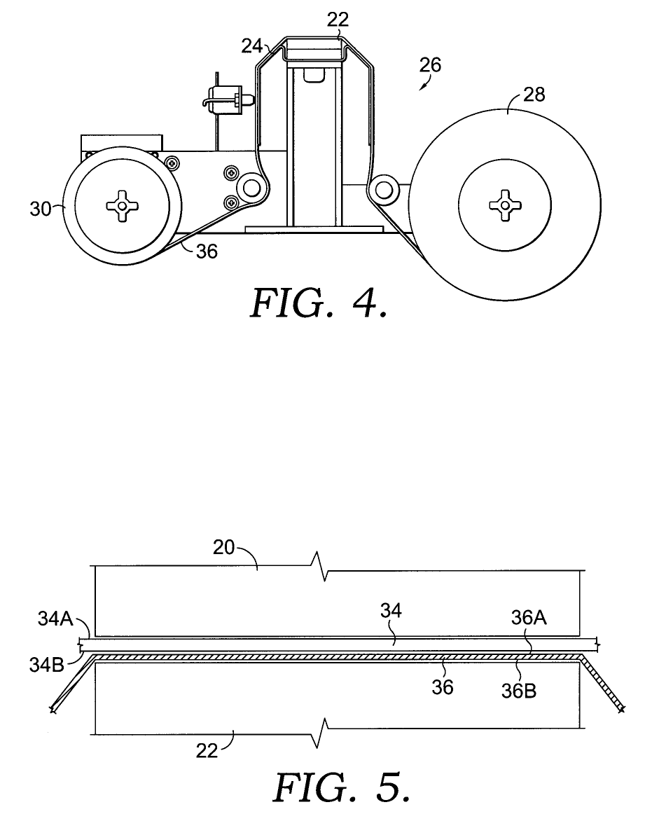

Yet another component of the apparatus 10 is an index mechanism 26, which has at least a supply portion and a collection portion. For an embodiment of the present invention, index mechanism 26 has at least two reels 28 and 30, with first reel 28 serving as the supply portion and second reel 30 serving as the collection portion. A portion of the heated platen assembly 18 and the index mechanism 26 are shown greater detail in FIG. 4. The index mechanism 26 also includes the components necessary to start and stop movement of the individual reels. However, these electromechanical components are well-known in the art and will therefore not be described in greater detail. Also shown in FIG. 4 is a continuous web of pre-printed transfers 36 in the form of a roll passing from the first reel 28, across the lower platen 22, and onto the second reel 30. Alternate embodiments of continuous web 36 can include sheets of pre-printed transfers that are indexed from the supply portion to the collection portion. A power cord 31 is also provided to facilitate the supplying of electricity to the apparatus 10 to power, among other things, the control mechanisms, the components to move the reels, and the heated platen assembly 18.

For operator protection, a safety bail 32 may be positioned substantially around the heat head 20, as can be seen in FIGS. 1-3. The safety bail 32 is designed to be a fail-safe means to trigger raising of the heat head 20 should something or someone come in contact with the heat head. Since the heat head 20 is operating at an elevated temperature of up to 425 degrees Fahrenheit, injuries can occur if contact is made with the heat head 20 while it is in operation.

As previously discussed, the apparatus 10 is designed to provide an improved mechanism for transferring an object from a first surface to a second surface. More specifically, this apparatus is directed towards the application of a pre-printed transfer onto a substrate. For the embodiment shown in the figures, the first surface is a continuous web containing a plurality of pre-printed transfers and the second surface is a transfer-accepting substrate.

Referring now to FIG. 5, the heated platen assembly 18 and interaction between the heated platen assembly 18, a substrate 34, and a continuous web 36 is shown. As previously mentioned, the second member 22 of heated platen assembly 18 is a removable lower platen. This lower platen 22 is designed to be removable such that it can be replaced with another platen as necessary so that its surface area corresponds to the size of the object that is being applied to the substrate 34.

The first member 20 and the second member 22 are positioned so as to define a space therebetween. The space is adapted to receive the substrate 34 and the continuous web of pre-printed transfers 36 such that a first upper substrate surface 34A is to be engaged by a lower surface of the first member 20 and a first web surface 36B is to be engaged by an upper surface of the second member 22. Since the first member 20, also known as the heat head, is at an elevated temperature during operation, the substrate 34 is in conductive proximity to the heat head 20 and the continuous web 36, which is positioned between the substrate 34 and the lower platen, or second member, 22. The first member 20 is adapted to apply pressure to the first substrate surface 34A, thus compressing the substrate 34 and continuous web 36 between the first and second members 20, 22 such that a first lower substrate surface 34B contacts a first transfer surface 36A. Depending on the type of substrate and pre-printed transfer being applied, the pressure applied by the first member 20 to complete such a transfer can be as high as 70 pounds per square inch (psi). This pressure is supplied by a cylinder 38. In the present embodiment, the cylinder can be either hydraulic or pneumatic in nature and is activated by receiving a source of compressed fluid, either liquid or air. The cylinder 38, which could also be electrically operated or toggled, moves the first member 20 along a vertical path. The first member 20 is further adapted to apply heat to the continuous web 36 through the substrate 34 for the purpose of affixing the pre-printed transfer contained on the continuous web 36 to the substrate 34.

Also disclosed in the present invention is a method of applying a pre-printed transfer to a desired substrate. The method comprises the steps of providing an apparatus 10, as previously discussed, that has a framework 12 and an enclosure 16 positioned proximate an upper end of the framework 12. The enclosure 16 contains a plurality of control mechanisms for the apparatus 10. Also provided is a heated platen assembly 18 having a first member 20 and a second member 22, and an index mechanism 26, which in one embodiment, has a first reel 28 and a second reel 30. The first reel 28 contains a roll of continuous web 36 having a plurality of pre-printed transfers for application to the substrate 34. The second reel 30 receives the roll from the first reel 28 after the pre-printed transfer has been applied to the substrate 34.

Once the equipment has been provided and the continuous web 36 loaded onto the index mechanism 26, a desired temperature, pressure, and dwell time are set on the control mechanisms. Next, the first and second reels 28 and 30 are advanced such that the continuous web 36 is positioned on the second member, or lower platen, 22. Once the continuous web 36 containing the pre-printed transfer is in place, a substrate 34 is placed on top of the continuous web 36 and the apparatus 10 is then activated such that the first member, or heated platen, 20 is lowered onto the substrate 34. The first member 20 then applies a predetermined level of heat and pressure to the substrate 34 and, in turn, the pre-printed transfer on continuous web 36 for a predetermined dwell time, as programmed into the control mechanisms. The temperature, pressure, and time will vary depending on the type of pre-printed transfer and substrate material used. The temperature and pressure are maintained on the substrate 34 for the desired dwell time until the pre-printed transfer is applied to the substrate 34 from the roll which is fed from the first reel 28.

Once the pre-printed transfer has been applied to the substrate 34 from continuous web 36, the first member 20 is raised and the substrate 34 is removed. A majority of the processes are automatically controlled by the control mechanisms, such as the advancement of the reels containing the continuous web of pre-printed transfer, applying the pressure and heat to the substrate, and raising of the heat head. In this embodiment, the lowering of heat head 20 is controlled by pressure applied to a foot pedal 40. An electric cord 41 sends a signal from foot pedal 40 to the cylinder to control activation thereof. This configuration allows the operator to determine when proper positioning is achieved between the substrate 34, the continuous web of pre-printed transfer 36, and the heated platen assembly 18 before applying the transfer to the substrate 34. However, in an alternate embodiment, the lowering of the heat head 20 is also automated and controlled by the controlling mechanisms.

The apparatus and method of the present invention is applicable to a variety of uses and discussion of any single use is not meant to limit the scope of the invention, but to simply explain that one potential use. One such use is the application of a label to a piece of fabric. That is, the direct application of the label to the fabric, without using a tag containing the relevant information such as the type that is traditionally sewn into the fabric. In such an arrangement, a roll of labels, or transfers, are placed on the first reel 28 and advanced to a second reel 30. The desired temperature, pressure, and dwell times are set on the control mechanisms. For the application of a pre-printed transfer 36 fabricated from Plastisol that is to be applied to a substrate 34 having a 50% cotton/50% polyester composition, such as that of a typical t-shirt, the operator programs the apparatus, to heat the first member, or heat head 20, to a temperature of 375 deg. F. and apply a pressure of 30 psi to the substrate 34 and the continuous web of pre-printed transfer 36 for a dwell time of three seconds. These conditions are for this type of transfer and substrate only and are subject to variation based upon the type of transfer and substrate used.

Through the pressure and heat subjected to the substrate 34, the pre-printed transfer separates from the continuous web 36 and is applied to the substrate 34. The heated platen 20 is then raised and the substrate 34 removed, either by the operator or other means. Once the substrate 34 is removed, the continuous web 36 is advanced to the collection portion such that a new transfer is placed above the second member, or lower platen 22.

The present invention provides numerous advantages over similar apparatuses of the prior art. The orientation of the continuous web 36 being placed directly above the lower platen 22 allows for easier centering of the transfer onto the substrate 34 since an operator has a better view of the continuous web 36 relative to the lower platen 22. The operator can more accurately determine that the continuous web 36, and hence the pre-printed transfer, is positioned properly on the lower platen 22, such that the entire transfer will be applied to the substrate 34. In previous arrangements, in which the transfer was placed over the substrate 34, the substrate 34 would typically cover the lower platen 22 and it was not possible to verify the positioning of the transfer relative to the lower platen 22. In order to obtain a complete application of the transfer to the substrate 34 it is necessary that both of the platens 20, 22 fully sandwich the continuous web 36 over the desired area of the substrate 34. This is better accomplished under the arrangement disclosed in the present invention.

A further benefit of the present invention is a more secure application of the transfer onto the substrate 34. The heat applied to the substrate 34 draws the transfer from the continuous web 36 and onto the substrate 34 since the first transfer surface 36A is in direct contact with the substrate 34. Instead of applying heat directly to the transfer, as in prior arrangements, it has been determined that the transfer can be more securely attached to the substrate 34 by applying the heat directly to the substrate 34. This arrangement and process yields fewer quality rejections for incomplete transfer applications to the substrate 34.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed herein need be carried out in the specific order described.

The invention claimed is:

1. An apparatus for transferring an object from a first surface to a second surface at an elevated temperature and increased pressure, said apparatus comprising:
a framework;
an enclosure positioned proximate an upper end of said framework, said enclosure containing a plurality of control mechanisms for said apparatus;
a heated platen assembly coupled with the framework, the assembly having first and second members, wherein at least one of the members is movable toward and away from the other member to selectively vary a distance therebetween; and,
an index mechanism coupled with the framework and having at least a supply portion and a collection portion.

2. The apparatus of claim 1, wherein said heated platen assembly includes a heat head, a removable lower platen, and a skirt assembly, wherein the heat head is selectively movable in a generally vertical direction toward and away from the lower platen.

3. The apparatus of claim 2, wherein the lower platen has a surface area substantially corresponding to the size of the object to be transferred.

4. The apparatus of claim 2, wherein the object is a pre-printed transfer.

5. The apparatus of claim 4, wherein the first surface is a continuous web containing a plurality of pre-printed transfers and wherein the second surface is a transfer-accepting substrate.

6. The apparatus of claim 5, wherein the substrate is positionable adjacent to and in conductive proximity with the heat head and wherein the preprinted transfer is positioned between the substrate and the lower platen.

7. The apparatus of claim 6, wherein the heated platen selectively operates at a temperature up to 425 degrees Fahrenheit and applies a pressure up to 70 pounds per square inch to the substrate and the pre-printed transfer.

8. The apparatus of claim 1, wherein the plurality of control mechanisms includes temperature, pressure, timing, and position controls.

9. The apparatus of claim 1, further comprising a safety bail positioned substantially around one of the members of the heated platen assembly.

10. An apparatus for applying a pre-printed transfer from a continuous web onto a substrate, the pre-printed transfer having a first transfer surface and the continuous web having a first web surface, the substrate having a first substrate surface and a second substrate surface, the apparatus comprising:
a first member;
a second member spaced apart from the first member to define a space therebetween, the space adapted to receive the substrate and the continuous web of pre-printed transfer such that the first substrate surface is engaged by the first member and the first web surface is engaged by the second member;
wherein the first member is configured to selectively apply a pressure to the first substrate surface, thus compressing the substrate and the continuous web of pre-printed transfer between the first and second members; and
wherein the first member is further configured to selectively apply heat to the continuous web of pre-printed transfer through the substrate for the purpose of affixing the pre-printed transfer to the substrate.

11. The apparatus of claim 10, further comprising a framework coupled with and supporting the first and second members.

12. The apparatus of claim 11 further comprising an enclosure coupled with the framework, the enclosure having a plurality of control mechanisms for the apparatus.

13. The apparatus of claim 12, wherein the plurality of control mechanisms include at least one of temperature, pressure, timing, and position controls.

14. The apparatus of claim 12, wherein the first member is a heat head that is movable in a generally vertical direction and wherein the second member is a removable lower platen.

15. The apparatus of claim 14, further comprising an index mechanism having at least a supply portion containing a continuous web of the pre-printed transfers for application to the substrate and a collection portion for receiving the continuous web after the pre-printed transfer has been applied to the substrate.

16. The apparatus of claim 14, further comprising a safety bail positioned substantially around the heat head, wherein the framework has a plurality of supports proximate a lower end for positioning of said apparatus, and wherein the enclosure is positioned proximate an upper end of the framework.

17. A method of applying a pre-printed transfer to a desired substrate, the method comprising:
a) providing an apparatus having a framework, an enclosure positioned proximate an upper end of the framework, the enclosure having a plurality of control mechanisms for the apparatus, a heated platen assembly having a first member and a second member, and an index mechanism having a supply portion containing a continuous web of the pre-printed transfers for application to the substrate and a collection portion for receiving the continuous web from the supply portion after the pre-printed transfer has been applied to the substrate;
b) setting at least one of a desired temperature, pressure, and dwell time on the control mechanisms;
c) advancing the supply and collection portions such that that the continuous web of pre-printed transfer is positioned on the second member;
d) placing the substrate on the continuous web of pre-printed transfer and the second member;
e) activating the apparatus to lower the first member onto the substrate;
f) applying a predetermined level of heat and pressure to the substrate and the continuous web for a dwell time such that the pre-printed transfer is applied to the substrate from the continuous web;
g) raising the first member and removing the substrate; and
h) advancing the continuous web to the collection portion such that another pre-printed transfer is positioned on the lower platen.

18. The method of claim 17, wherein the lowering and raising of the first member is controlled by pressure applied to a foot pedal by an operator.

19. The method of claim 17, wherein steps c) and f) and g) are automated and controlled by the control mechanisms.

20. The method of claim 19, wherein step e) is automated and controlled by the control mechanisms.
